(19) United States
(12) Patent Application Publication
(10) Pub. No.: US 2008/0245168 A1
(43) Pub. Date: Oct. 9, 2008

(54) Automatic Transmission and Shift Control Method For Said Transmission

(75) Inventor: Karl-Fritz Heinzelmann, Meckenbeuren (DE)

Correspondence Address: DAVIS BUJOLD & Daniels, P.L.L.C., 112 PLEASANT STREET, CONCORD, NH, 03301, US

(73) Assignee: ZF Friedrichshafen AG, Friedrichshafen (DE)

(21) Appl. No.: 12/089,943

(22) PCT Filed: Sep. 26, 2006
(86) PCT No.: PCT/EP2006/009337

§ 371 Date: Apr. 11, 2008

(30) Foreign Application Priority Data
Oct. 19, 2005 (DE) 10 2005 050 067.6

(51) Int. Cl. F16H 61/04

(52) U.S. Cl. 74/335

(57) ABSTRACT

The invention concerns an automated manual transmission of a motor vehicle, having an input shaft, an output shaft arranged co-axially with reference to the input shaft, and several gears, which can be selectively shifted via allocated shifting clutches, in which the input shaft is connected to a driving motor via a motor clutch, which can be engaged and disengaged, and an additional controllable friction clutch is provided as power shift clutch if required for bridging at least one of the shifting clutches. In an arrangement, which is improved operationally and from the point of view of a retrofitting of an existing manual transmission, the power shift clutch (K′) operates directly between the driving motor (M) and the output shaft (W2 or W5), the power shift clutch (K′) is arranged co-axially with reference to the motor clutch (K) on the input side of the manual transmission (1, 1′), the transmission shafts (W1 or W1, W2, W4) located axially between the power shift clutch (K′) and the output shaft (W2 or W5) are configured as hollow shafts, and the output shaft (W2 or W5) is extended within these transmission shafts (W1 or W1, W2, W4) up to the part of the power shift clutch (K′) located on the transmission side.

This application is a national stage completion of PCT/EP2006/009337 filed Sep. 26, 2006, which claims priority from German Application Ser. No. 10 2005 050 067.6 filed Oct. 19, 2005.

### FIELD OF THE INVENTION

The invention concerns an automated manual transmission of a motor vehicle, having an input shaft with an output shaft, arranged co-axially with reference to the input shaft, and several gears, which can be selectively shifted, via allocated shifting clutches, in which the input shaft is connected to a driving motor, via a motor clutch which can be engaged and disengaged, and an additional controllable friction clutch is provided as a power shift clutch for bridging, if required, at least one of the shifting clutches.

### BACKGROUND OF THE INVENTION

The invention concerns a process for shift control of an automated manual transmission of a motor vehicle, which has an input shaft, an output shaft arranged co-axially with reference to the input shaft, and several gears, which can be selectively shifted, via allocated shifting clutches. The input shaft is connected to a driving motor, via a motor clutch, which can be engaged and disengaged, where an additional controllable friction clutch, provided as a power shift clutch for bridging the shifting clutches that participate in the shifting operation, is engaged during a shifting operation.

Automated manual transmissions are being increasingly used in motor vehicles as well as in passenger vehicles and also in the commercial vehicle sector, since they have a high operating comfort with relatively low weight, compact dimensions, and a high transmission efficiency factor due to the automated shifting operations, and also make low fuel consumption of the relevant vehicles possible. A disadvantage of automated transmissions is, however, the design-related interruption of the power flow, between the driving motor and the axle drive connected to the output shaft during a gear change, which occurs because the motor clutch is momentarily disengaged and the manual transmission is temporarily idle. An undesirable deceleration of the motor vehicle can thus occur, especially with a coasting upshift while driving on an upward slope, and an undesirable acceleration of the motor vehicle can occur during a shift-in, especially with a coasting downshift while driving on a downward slope. This leads generally to lag and an uncomfortable sequence in the shifting operation.

It is therefore known, in particular in commercial vehicles, to accelerate synchronization of the gears to be respectively engaged in an upshift by way of the gear brake or to assist it by way of an intervention in the motor control with an engaged motor clutch and, if required, by way of a motor brake during upshifts in order to shorten the power interruption during shifting operations, however this is connected with an increased complexity of the auxiliary equipment.

The invention also concerns a simple automated manual transmission in countershaft design or in planetary design with claw clutches, which are predominantly used in passenger cars and light trucks, as well as group transmissions, which consist of several serially connected, partial transmissions and are predominantly used in heavy trucks. A group transmission of this type is known from DE 100 51 354 A1, in the form of a range change, group transmission, which consists of a simple main transmission in countershaft design and a range group in planetary design connected downstream thereof.

It is known that an automated manual transmission can be provided with an additional controllable friction clutch, such that the input shaft of the transmission can be connected to its output shaft during a shifting operation in order to prevent a tractive power interruption during a shifting operation. A gear change can thus be carried out as a power shift without tractive power interruption or at least as a partial power shift with reduced torque transmission.

An automated manual transmission, such as this, is described in DE 198 59 458 A1, which is a manual transmission in countershaft design in which an additional friction clutch, acting as a power shift clutch, is arranged parallel to the shifting clutch of a gear wheel, preferably on the loose gear wheel of the highest gear. The disadvantage of this manual transmission is the arrangement of the additional shifting clutches within the manual transmission, since a corresponding retrofitting of an existing manual transmission is, for this reason, either not at all possible due to a lack of space, or can be realized only by carrying out many modifications. The arrangement of the additional friction clutch requires, in addition, that the motor clutch remain engaged during the shifting operation, which at least complicates the disengagement of the low gear and the synchronization and engagement of the target gear.

Against this background, it is an object of the invention to propose an arrangement of a power shift clutch on an automated manual transmission of the kind described above, which is more advantageous operationally and from the point of view of retrofitting an existing manual transmission. A process for shift control of an automated manual transmission such as this is also disclosed.

The object is attained with reference to the manual transmission, wherein it is disclosed that the power shift clutch operates directly between the driving motor and the output shaft; the power shift clutch is arranged co-axially with reference to the motor clutch located on the input side of the manual transmission; the transmission shafts located axially between the power shift clutch and the output shaft are configured as hollow shafts, and the output shaft is extended within these transmission shafts up to the part of the power shift clutch located on the side of the transmission.

The motor clutch and all of the shifting clutches of the manual transmission are bridged in this way by engaging the power shift clutch, whereby shifting operations with a disengaged and an engaged motor clutch are possible.

In addition, the power shift clutch in the provided arrangement can be arranged outside of the transmission housing of the manual transmission so that any existing manual transmissions can be retrofitted as power shift transmissions with relatively small effort, namely by replacing the output shaft by way of an extended configuration thereof and replacing the transmission shafts located co-axially thereto with hollow shafts.

### SUMMARY OF THE INVENTION

A power shift clutch can also be configured in principle as a dry clutch and as a hydrostatic multiple disc clutch. The design of the power shift clutch is practically oriented toward loads occurring during operation, especially the thermal load, and toward the design of the motor clutch in whose clutch housing the power shift clutch is advantageously arranged, especially when it has an identical design, in order to reduce the installation space requirement. It is also advantageous in this sense to provide the power shift clutch and the motor clutch with a shared clutch basket.

In a widely propagated embodiment of the manual transmission as a simple countershaft transmission having an input shaft, an output shaft arranged co-axially thereto and a countershaft arranged parallel to these transmission shafts, the input shaft is consequently configured as a hollow shaft and the output shaft of the manual transmission extends within the input shaft up to the power shift clutch located on the side of the transmission. In this way, all of the shifting mechanisms can then be realized as power shifts or partial power shifts within the manual transmission by way of the power shift clutch.

In an embodiment of the manual transmission as a group transmission with a main transmission in simple countershaft design and a range group in planetary design connected downstream thereof, the input shaft and the output shaft of the main transmission, as well as the input shaft of the range group, are accordingly configured as hollow shafts. The output shaft of the range group which, in this case, forms the output shaft of the whole transmission, extends within the output shaft of the range group, as well as within the output shaft, and the input shaft of the main transmission up to the part of the power shift clutch located on the side of the transmission. In this way, aside from the shifting mechanisms within the main transmission, range shifts can also be realized as power shifts or partial power shifts within the range group.

Aside from the mentioned exemplary embodiments of the manual transmissions, the arrangement of a power shift clutch, according to the invention, can be applicable in all types of manual transmissions or group transmissions having co-axial input and output shafts.

The object is attained with reference to the process for shift control, wherein it is disclosed that a direct connection between the driving motor and the output shaft must be established before disengaging the low gear for torque transfer by way of an at least partial engagement of the power shift clutch in a shifting operation between two gears containing a maximum of one direct gear (i>=1), the low gear is then disengaged, the target gear is subsequently synchronized, as well as engaged, and finally the power shift clutch is again fully disengaged.

The torque, transmitted by the driving motor, via the motor clutch, to the input shaft is transferred for the most part by at least partially engaging the power shift clutch. The shifting clutch of the engaged low gear is disengaged in this way and can thus be disengaged for the most part free of load in order to disengage the low gear. An unencumbered synchronization of the target gear to be engaged can, likewise, be carried out in this way and the target gear can be subsequently engaged.

The shifting operations, insofar as they do not include an overdrive gear (i<1), can thus be carried out as a partial power shift without interruption of the power flow by way of the arrangement of the power shift clutch, according to the invention. An undesirable deceleration or acceleration of the motor vehicle is prevented in this way so that the shifting operations can be carried out overall faster and more comfortably. Motor jerks and vibrations are prevented by virtue of the load-induced stress maintained within the drivetrain, which is associated with reduced wear of the critical components of the drivetrain and an overall higher driving comfort. Other devices, provided for shifting operations with the purpose of reducing the input speed of the manual transmission, such as a transmission brake or a motor brake, can be eliminated or omitted.

The power shift clutch is almost always controlled in slip control mode during shifting operations as a result of the generally more direct gear transmission ratio as compared to the gear transmission ratio of the low gear.

The lone exception to this is constituted by a shifting operation from the direct gear (i=1) into a lower gear (i>1) in which the power shift clutch can be at least temporarily fully engaged for torque transfer.

When a shifting operation is carried out with a disengaged motor clutch, that is, the motor clutch is disengaged before disengaging the low gear, then the disengagement of the power shift clutch at the end of the shifting operation, for the purpose of achieving a jolt-free speed and torque adaptation, can advantageously take place overlapped in time with the engaging of the motor clutch.

It is, however, also possible to keep the motor clutch engaged during a shifting operation. In this case, synchronization of the target gear can be at least practically assisted by way of a change of the transferrable torque of the power shift clutch by further engaging the power shift clutch for synchronization of the target gear during an upshift operation and further disengaging the latter during a downshift operation The load of the driving motor is increased by way of further engaging of the power shift clutch and the drivetrain located on the input side is thus decelerated. The driving motor is unloaded by way of further disengaging the power shift clutch and the drivetrain, located on the input side, is thus accelerated by way of the rapidly rotating driving motor. As a result of this type of assistance the synchronization, the usual synchronization means, such as the friction ring synchronization devices allocated to the shifting clutches, can have a more compact design or can be omitted altogether, if required, because of the low load.

### BRIEF DESCRIPTION OF THE DRAWINGS

The invention will now be described, by way of example, with reference to the accompanying drawings in which:

FIG. 1 shows a schematic representation, first embodiment of a manual transmission according to the invention, and

FIG. 2 shows a schematic representation, second embodiment of a manual transmission according to the invention.

### DETAILED DESCRIPTION OF THE INVENTION

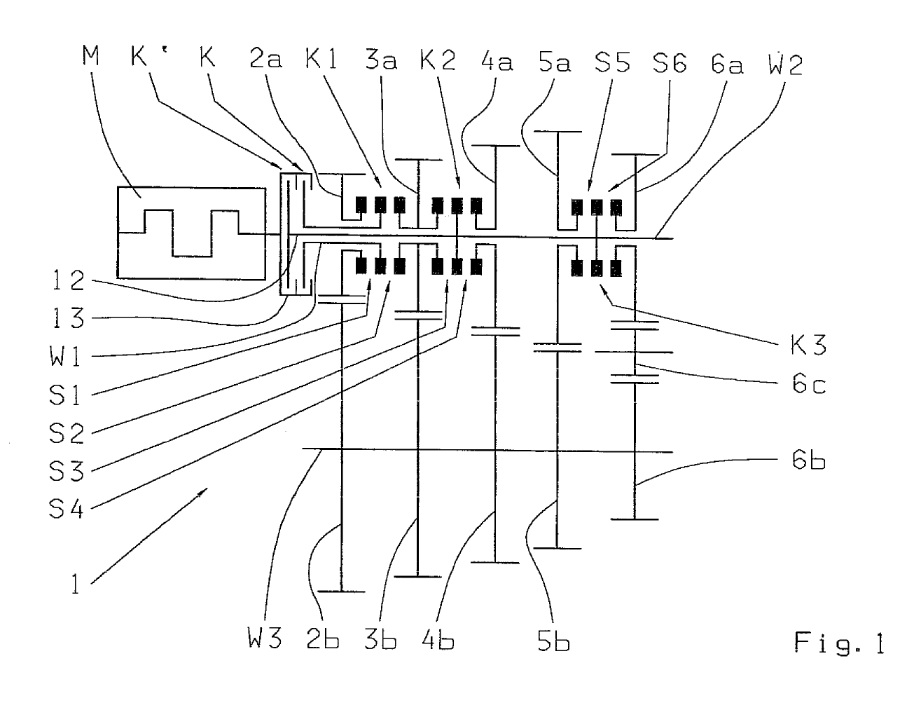

An automated manual transmission 1, according to FIG. 1, is configured as a simple countershaft transmission having an input shaft W1, an output shaft W2 arranged co-axially within the input shaft, and a countershaft W3 arranged parallel to the two transmission shafts W1, W2. The input shaft W1 of the manual transmission 1 is connected on the input side, via a motor clutch K, which can be disengaged and engaged to a driving motor M, configured as an internal combustion engine. The manual transmission 1 has four forward gears and one reverse gear, which can be selectively shifted.

The input shaft W1 can be coupled in a shifting position S1 to a loose gear wheel 2a of a first gear wheel pair 2a, 2b in the interior of the transmission, via a first shifting clutch K1 in order to shift the gears, such that a driving connection can be produced between the input shaft W1 and the countershaft W3 by virtue of the fixed connection of the fixed gear wheel 2b to the countershaft W3. As an alternative, the input shaft W1 can also be coupled by way of the first shifting clutch K1 in a shifting position S2 to a loose gear wheel 3a of a second gear wheel pair 3a, 3b.

The loose gearwheel 3a can be coupled to the output shaft W2 by shifting a second shifting clutch K2 into a shifting position S3 so that a direct connection of the input shaft W1 with the output shaft W2 is produced, in this case, (in which the first shifting clutch K1 is in the shifting position S2) and the fourth forward gear, conceived as a direct gear (i=1), can thus be engaged.

The next lower third, forward gear is engaged by shifting the first shifting clutch K1 into the shifting position S1 and shifting the second shifting clutch K2 into the shifting position S3, such that power flow from the input shaft W1 takes place, via the gear wheel pairs 2a, 2b and 3a, 3b, into the output shaft W2. The remaining gears are obtained in a similar way in the order second forward gear, first forward gear and reverse gear, with the first shifting clutch K1 located in the shifting position S1; by shifting the second shifting clutch K2 into a shifting position S4; by shifting the third shifting clutch K3 into a shifting position S5, and by shifting the third shifting clutch K3 into a shifting position S6, such that the required reversal of direction of rotation is realized in the reverse gear by way of an idler gear 6c arranged between an allocated loose gear wheel 6a and a pertinent fixed gearwheel 6b.

According to the invention, a power shift clutch K′, configured as a friction clutch, is arranged co-axially with reference to the motor clutch K on the input side of the manual transmission 1 and can be connected, via the driving motor M directly to the output shaft W2. For this purpose, the input shaft W1 is configured as a hollow shaft and the output shaft W2 has an extension 12 extending through the center of the input shaft W1 up to the part of the power shift clutch K′ located on the side of the transmission. The power shift clutch K′ and the motor clutch K have a common clutch basket 13 available.

The motor clutch K, as well as all of shifting clutches K1, K2, K3 can be bridged by way of the power shift clutch K′. All of the shifting operations within the manual transmission 1 can be carried out as a power shift or partial power shift without tractive power interruption by way of the temporary, at least partial engagement of the power shift clutch K′, such that the motor clutch K can be kept selectively disengaged or engaged during a shifting operation depending upon the precise control of the shifting operations. The easy retrofitting of an existing countershaft transmission without a power shift clutch to a power shift transmission is possible in addition by way of the external arrangement of the power shift clutch K′ outside of the manual transmission 1.

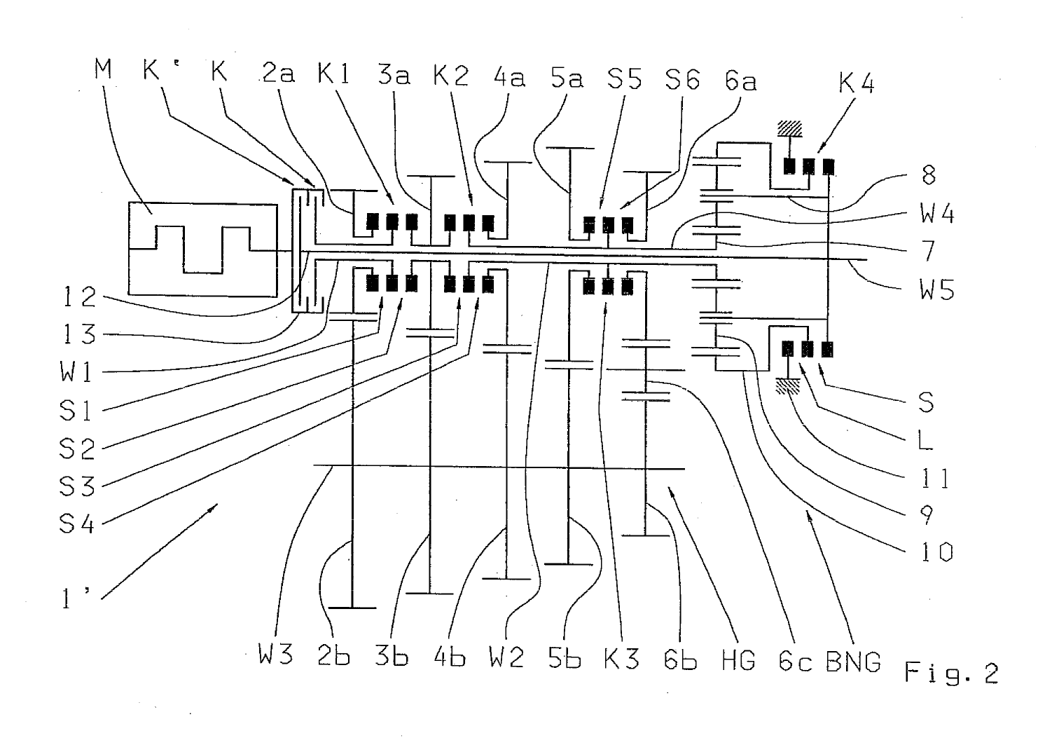

A further automated manual transmission 1′, according to FIG. 2, is configured as a group transmission with a main transmission HG and a range group BNG connected downstream thereof. The main transmission HG corresponds to the manual transmission 1, according to FIG. 1, and has four forward gears, as well as one reverse gear, wherein the input shaft W1 of the main transmission HG is connected on the input side to the driving motor M via the motor clutch K.

The range group BNG connected downstream is configured as a planetary transmission, having an input shaft W4 and an output shaft W5, arranged co-axially thereto, where the input shaft W4 is fixedly connected to the output shaft W2 of the main transmission HG. The output shaft W5 of the range group BNG also forms the output shaft of the whole manual transmission 1′ or group transmission.

The range group BNG is configured as a simple planetary gearset with a sun gear 7, several planetary gears 9 rotatably mounted on a planetary carrier 8 and in meshing engagement with the sun gear 7, as well as a hollow gear 10 in meshing engagement with the planetary gears 9. The sun gear 7 serves as input element of the range group BNG and is, therefore, rigidly connected to the input shaft W4. The planetary carrier 8 serves as an output element of the range group BNG and is, therefore, rigidly connected to the output shaft W5. The ring gear 10 is connected to the clutch basket 13 of a fourth shifting clutch K4, which can be selectively connected to a housing 11 in order to shift a slow gear stage L and to the planetary carrier 8 in order to shift a direct fast gear stage S. In the slow gear stage L, the planetary gears 9 shift with a corresponding gear reduction of the speed of the planetary carrier 8 between the rotating sun gear 7 and the fixed ring gear 10. In the fast gear stage S, all of the components of the planetary transmission rotate rigidly at the speed of the sun gear 7 because of the coupling of the ring gear 10 to the planetary carrier 8.

A power shift clutch K′, configured as a friction clutch, which is arranged on the input side of the main transmission HG, co-axially with reference to the motor clutch K, is also provided, according to the invention, and can be used to directly connect the output shaft W5 of the range group BNG to the driving motor M. For this purpose, the input shaft W1 and the output shaft W2 of the main transmission HG and the input shaft W4 of the range group BNG are configured as hollow shafts. In addition, the output shaft W5 of the range group BNG ends, via the extension 12, passing through the center of transmission shafts W1, W2, W4 at the part of the power shift clutch K′ located on the side of the transmission. The power shift clutch K′ and the motor clutch K, in turn, have a common clutch basket 13.

The motor clutch K, as well as all of the shifting clutches K1, K2, K3 K4, can be bridged by way of the power shift clutch K′. All of the shifting operations within the main transmission HG, as well as the range shifts within the range group BNG, can be carried out as power shift or partial power shift without tractive power interruption by way of the temporary, at least partial engagement of the power shift clutch K′, where the motor clutch K can be kept selectively disengaged or engaged during a shifting operation, depending upon the precise control of the shifting operations. The easy retrofitting of an existing group transmission BNG without power shift clutch to a power shift transmission is also possible by way of the externally arranging of the power shift clutch K′ outside of the main transmission HG.

### REFERENCE NUMERALS

1 automated manual transmission

1′ automated manual transmission

2a loose gear wheel

2b fixed gear wheel

3a loose gear wheel

3b fixed gear wheel

4a loose gear wheel

4b fixed gear wheel

5a loose gear wheel

5b fixed gear wheel

6a loose gear wheel

6b fixed gear wheel

6c idler gear

7 sun gear

8 planetary carrier

9 planetary gear

10 hollow gear

11 housing

12 extension

13 clutch basket

BNG range group

HG main transmission

i gear transmission ratio

K motor clutch

K′ power shift clutch

K1 (first) shifting clutch

K2 (second) shifting clutch

K3 (third) shifting clutch

K4 (fourth) shifting clutch

L shifting position (of K4), slow gear stage (of BNG)

M driving motor

S shifting position (of K4), fast gear stage (of BNG)

S1 shifting position (of K1)

S2 shifting position (of K1)

S3 shifting position (of K2)

S4 shifting position (of K2)

S5 shifting position (of K3)

S6 shifting position (of K3)

W1 input shaft (of 1, 1′, HG)

W2 output shaft (of 1, HG)

W3 crankshaft (of 1, HG)

W4 input shaft (of BNG)

W5 output shaft (of 1′, BNG)

1-10. (canceled)

11. An automated manual transmission (1, 1′) for a motor vehicle, the transmission (1, 1′) comprising:
an input shaft,
an output shaft (W2, W5) which is co-axial with the input shaft, and
a plurality of gears which are selectively engagable via shifting clutches (K1, K2, K3, K4);
a motor clutch (K) engaging the input shaft with a driving motor (M);
a power shift clutch (K′) being co-axial with the motor clutch (K) and being located on an input side of the transmission (1, 1′),
the power shift clutch (K′) directly engaging the driving motor (M) and the output shaft (W2, W5) to bridge at least one of the shifting clutches (K1, K2, K3, K4);
a plurality of hollow transmission shafts (W1, W2, W4) are axially located between the power shift clutch (K′) and the output shaft (W2, W5), the output shaft (W2, W5) extending through the hollow transmission shafts (W1, W2, W4) to the power shift clutch (K′);
the transmission (1′) being a group transmission with a main transmission (HG) with a simple countershaft design and a range group (BNG) having a planetary design, the range group (BNG) being coupled to the main transmission (HG) and located downstream therefrom; and
an input shaft (W1) and an output shaft (W2) of the main transmission (HG) and an input shaft (W4) of the range group (BNG) are hollow shafts, and an output shaft (W5) of the range group (BNG) extending through the input shaft (W4) of the range group (BNG) and the output shaft (W2) and the input shaft (W1) of the main transmission (HG) to the power shift clutch (K′).

12. The manual transmission of claim 11, wherein the power shift clutch (K′) is located within a clutch housing of the motor clutch (K).

13. The manual transmission of claim 12, wherein the power shift clutch (K′) and the motor clutch (K) have a common clutch basket (13).

14. The manual transmission of claim 11, wherein the input shaft (W1) of the manual transmission (1) is a hollow shaft in a configuration of the manual transmission (1) of the simple countershaft design, and the output shaft (W2) of the manual transmission (1) extends through the input shaft (W1) to the power shifting clutch (K′).

15. A method of controlling shifting of an automated manual transmission of a motor vehicle having an input shaft, an output shaft arranged co-axially with the input shaft, and several gears which can be selectively shifted via shifting clutches, and in which the input shaft is connected to a driving motorvia a motor clutch, an additional controllable power shift clutch engages to bridge the shifting clutches that participate during a shifting operation, and the method comprising the steps of:
at least partially engaging the power shift clutch (K′) to establish a direct connection between the driving motor (M) and the output shaft (W2 or W5) and to transfer torque before disengaging a low gear during a shifting operation between two maximum gears (i>=1) containing a direct gear;
disengaging the low gear;
synchronizing and engaging a target gear;
fully disengaging the power shift clutch (K′); and
maintaining engagement of the motor clutch (K) during the shifting operation, and assisting the synchronization of the target gear by changing the torque transferred by the at least partially engaged power shift clutch (K′).

16. The process of claim 15, further comprising the step of disengaging the motor clutch (K) before disengaging the low gear, and overlapping the disengagement of the power shift clutch (K′) and the engagement of the motor clutch (K).

17. The process of claim 15, further comprising the step of further engaging the power shift clutch (K′), during an upshift, for synchronization of the target gear.

18. The process of claim 15, further comprising the step of further disengaging the power shift clutch (K′), during a downshift, for synchronization of the target gear.
